(19) United States
(12) Patent Application Publication
(10) Pub. No.: US 2023/0215086 A1
(43) Pub. Date: Jul. 6, 2023

(54) METHOD FOR EFFECTIVE HAT ANALYSIS DISPLAY IN AVIONICS SOFTWARE

(71) Applicant: ASELSAN ELEKTRONIK SANAYI VE TICARET ANONIM SIRKETI, Ankara (TR)

(72) Inventors: Ahmet Bora UYSAL, Ankara (TR); Huseyin UNAL, Ankara (TR); Yusuf PASA, Ankara (TR)

(73) Assignee: ASELSAN ELEKTRONIK SANAYI VE TICARET ANONIM SIRKETI, Ankara (TR)

(21) Appl. No.: 18/090,535

(22) Filed: Dec. 29, 2022

(30) Foreign Application Priority Data
Dec. 30, 2021 (TR) 2021/021969

(51) Int. Cl. G06T 15/80; G06T 17/05

(52) U.S. Cl. CPC G06T 15/80; G06T 17/05

(57) ABSTRACT

A method for effective Height Above Terrain (HAT) analysis display in avionics software is provided. The method enables the display of height above terrain analysis with high performance by the usage of high resolution data. The method includes preparing a shader program, mapping program variables, compiling the shader program, activating the compiled shader program and executing all graphics processing instructions; transferring elevation tiles and running the shader program; transferring an aircraft altitude; and running the shader program, comparing each cell's elevation value to the aircraft altitude and interpreting the difference in values, and displaying a colour value.

### CROSS REFERENCE TO THE RELATED APPLICATIONS

This application is based upon and claims priority to Turkish Patent Application No. 2021/021969, filed on Dec. 30, 2021, the entire contents of which are incorporated herein by reference.

### TECHNICAL FIELD

The Invention relates to a method for effective Height Above Terrain (HAT) analysis display in avionics software enabling display of height above terrain analysis with high performance by the usage of high resolution data.

In particular, the invention relates to a method for effective HAT analysis display in avionics software that allows fixed wing/rotary wing platforms to avoid terrain in situations when there is low visibility, allowing the analysis to be displayed with high resolution data and in high performance.

### BACKGROUND

Today avionics systems are used in aircrafts, artificial satellites, and space crafts. These avionics systems consist of hundreds of systems installed on the aircraft that perform communication, navigation, display and management of multiple individual functions. There are various types of such systems ranging from a simple system such as a searchlight of a police helicopter to complicated systems such as the ones installed on airborne early warning platforms.

Navigation systems send the aircraft position to cockpit display systems which help pilot to see the route and also to ground stations. Flight control systems are rather related to automatic control of aircraft flight.

In the related art, the method of displaying HAT analysis on cockpit displays involves comparing aircraft altitude with the height value of all elevation data cells contained within displayed coordinates. In the present related art, this analysis brings a significant processing load for control unit depending on the size of the screen. As the displayed data is critical for pilots, refresh time is also highly important. To overcome such processing load, low resolution data is used for analysis in present products or analysis refresh rate is reduced.

Upon search made in the subject matter, the application numbered TR2013/11703 is encountered. The application relates to a displaying and control interface for avionics systems. However, it does not disclose any method for effective HAT analysis display in avionics software.

As a result, due to disadvantages described above and the inadequacy of existing solutions, it has been necessary to make development in the related art.

### SUMMARY

The invention is inspired from existing situations and aims to solve the disadvantages described above.

Primary aim of the invention is to store elevation data in tiles in the aircraft and only process the elevation tiles contained geographically on the screen as images in the aircraft computer graphics card by comparing elevation data in each tile with the aircraft altitude and displaying the resulting coloured analysis image.

Another aim of the invention is to provide analysis of elevation data in proper resolution without any data loss to users in analysis display.

In order to achieve above mentioned purposes, in an alternative embodiment of the invention, the invention is a method for effective HAT analysis display in avionics software enabling the display of height above terrain analysis with high performance and in high resolution in the aircraft by the usage of high resolution data and includes of process steps of preparation of elevation tiles of DTED (Digital Terrain Elevation Data), indexing the prepared data using binary search tree and loading the data into aircraft computer, loading elevation data into aircraft computer control unit memory, transferring related elevation tiles from aircraft computer control unit memory to graphics card memory, preparation of graphics shader program running on graphics card in the aircraft, compiling the prepared shader program, activation of the compiled shader program and execution of shader program in execution cycles, transfer of aircraft altitude in the same unit (meter) from control unit memory to a register in graphics card in each execution cycle, comparison of aircraft altitude and each elevation cell in elevation tile in the graphics card, obtaining a value based on the differences between the elevation cell's elevation and aircraft's altitude, analysing the difference between the values, displaying a colour based on the difference for the pixel.

The structural and characteristics features of the invention and all advantages will be understood better in detailed descriptions with the figures given below and with reference to the figures, and therefore, the assessment should be made by considering the said figures and detailed explanations.

### BRIEF DESCRIPTION OF THE DRAWINGS

FIG. 1 is an illustrative view of transformation of DTED (Digital Terrain Elevation Data) data into small Elevation Tiles (YP).

FIG. 2 is an illustrative view of process step of loading of Elevation Tiles into aircraft computer.

FIG. 3 is an illustrative view of digital map software in aircraft computer.

FIG. 4 is an illustrative view of process step of reading of Elevation Tiles by digital map software and loading tiles into graphics card memory.

FIG. 5 is an illustrative view of height above terrain analysis obtained from elevation tiles and aircraft altitude. (dark grey field represents red colour (high zones), light grey areas yellow (medium height zones), other areas not coloured (near sea level)).

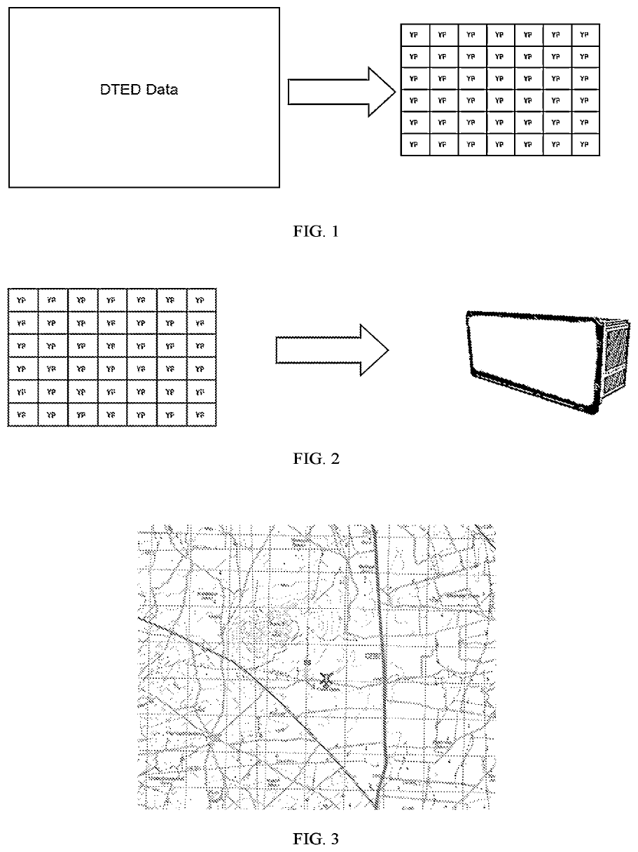

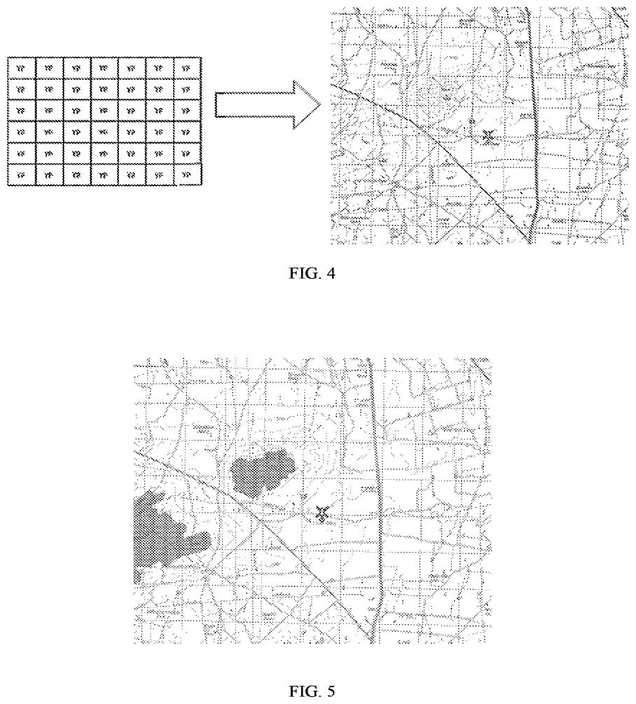

### DETAILED DESCRIPTION OF THE EMBODIMENTS

This detailed description describes the preferred embodiment of a method for effective Height Above Terrain (HAT) analysis display in avionics software of the invention, only for better understanding of the subject and does not cause any restrictive effect.

Height Above Terrain analysis enables the display of an analysis that allows pilots to avoid terrain in situations when there is low visibility, to be displayed with high resolution data and in high performance.

Method for effective HAT analysis display in avionics software includes of process steps of preparation of elevation data, loading elevation data into aircraft, installing shader program on aircraft computer graphics card, transfer of elevation data to graphics card, transfer of aircraft altitude to graphic card and processing the data in graphics card.

In preparation of data process step, DTED (Digital Terrain Elevation Data) data is used which has a resolution of 1 arc second per each cell ( 1/3600° degree, about 30 meters) resolution. First the data is transferred to aircraft after indexing each tile of 256×256 cells (65536 cells) with binary search tree algorithm.

In the process step of loading of data to aircraft, elevation tiles geographically entering the screen are found with binary search tree algorithm and loaded into aircraft memory.

In the process step of loading shader program in graphics card, registers and functions in graphics card are used in digital map software. Program variables are mapped to registers in the graphics card memory. Then the shader program is compiled and activated and then all the graphics processing instructions are executed in each execution cycle.

In process step of loading data to aircraft computer graphics card, elevation tiles loaded to control unit memory are transferred to graphics card without conducting any further process. The installed shader program is run to process transferred data for display.

In the process step of transfer of aircraft altitude to graphics card, aircraft altitude is transferred to graphics card registers from control unit memory in the same unit (meter) as elevation data cells in each execution cycle.

In the process step of processing data in graphics card, shader program on graphics card is executed for each cell in the elevation tiles in graphics card memory. Value of each cell (elevation value for the position represented by the cell) is compared to aircraft altitude transferred to a register in graphics card and if the difference is under a specified value, it is interpreted as red, if over a specified value, transparent if between those two values then as yellow and then the obtained colour is displayed.

1. A method for an effective HAT analysis display in avionics software enabling a display of height above terrain analysis with a high performance in aircrafts by a usage of high- resolution data, wherein the method comprises the following process steps:
preparing a shader program running on a graphics card in an aircraft computer by means of a digital map software, mapping program variables to registers in a graphics card memory, compiling the shader program to obtain a compiled shader program, activating the compiled shader program and executing all graphics processing instructions in each execution cycle,
transferring elevation tiles loaded onto an aircraft computer control unit memory to the graphics card and running the shader program installed on the graphics card,
transferring an aircraft altitude to a register on the graphics card in a same unit (meter) as elevation data cells from the aircraft computer control unit memory in each execution cycle,
running the shader program in the graphics card for each cell in the elevation tiles in the graphics card, comparing each cell's elevation value to the aircraft altitude to obtain a difference and interpreting the difference in values, and displaying a colour value.
